(19) United States
(12) Patent Application Publication
(10) Pub. No.: US 2025/0274025 A1
(43) Pub. Date: Aug. 28, 2025

(54) VIBRATOR

(71) Applicant: ALPS ALPINE CO., LTD., Tokyo (JP)

(72) Inventor: Ryota SUZUKI, Miyagi (JP)

(21) Appl. No.: 19/207,898

(22) Filed: May 14, 2025

Related U.S. Application Data
(63) Continuation of application No. PCT/JP2023/041011, filed on Nov. 15, 2023.

(30) Foreign Application Priority Data
Dec. 8, 2022 (JP) 2022-196421

(51) Int. Cl. H02K 33/18; H02K 7/08

(52) U.S. Cl. CPC H02K 33/18; H02K 7/08

(57) ABSTRACT

A vibrator includes a housing, a movable body, and a support to support the movable body, wherein the movable body includes a core and a coil, a permanent magnet is fixed inside the housing, and both poles of which face one end of the core, an inertial force in a direction opposite to a movement of the movable body is alternately transmitted to the housing, the support is a guide, and the movable body moves leftward when a current in one direction flows through the coil, with a further movement leftward being restricted by an attractive force between the one end of the core and one pole of the permanent magnet, and moves rightward when a current in another direction flows through the coil, with a further movement rightward being restricted by an attractive force between the one end of the core and another pole of the permanent magnet.

### CROSS-REFERENCE TO RELATED APPLICATIONS

This application is a continuation application of International Application No. PCT/JP2023/041011, filed on Nov. 15, 2023, and designated the U.S., which is based upon and claims priority to Japanese Patent Application No. 2022-196421, filed on Dec. 8, 2022. The entire contents of these applications are incorporated herein by reference.

### BACKGROUND OF THE INVENTION

### 1. Field of the Invention

The disclosure herein relates to vibrators.

### 2. Description of the Related Art

Conventionally, in electronic devices such as a mobile device (e.g., a smartphone, a mobile phone, a tablet terminal, etc.), a game machine, and an information display mounted on a vehicle such as an automobile, a vibration generating device is used, which is capable of generating vibration to give a user notification of various incoming communications (e.g., an incoming call, an incoming e-mail, or an incoming SNS message) and tactile feedback on user operations.

As a vibration generating device, it is known that a vibrator supported by an elastic support and a permanent magnet are placed inside a housing. An alternating current is supplied to an electromagnet provided in the vibrator, generating an alternating magnetic field around the electromagnet. This alternation produces attractive and repulsive forces between the electromagnet and the permanent magnet, causing the vibrator to oscillate in both longitudinal and transverse directions (directions perpendicular to a direction along a magnetic core) (see, e.g., Patent Literature (PTL) 1 below).

However, since the related vibration generating device supports the vibrator using an elastic member, it is difficult to flatten a frequency characteristic of the vibration generating device (i.e., to increase a bandwidth of a peak resonant frequency) due to an elastic action of the elastic member.

### CITATION LIST

### Patent Literature

[PTL 1] Japanese Laid-Open Patent Publication No. 2016-96677

### SUMMARY OF THE INVENTION

A vibrator includes a housing, a movable body housed in the housing, and a support configured to support the movable body, the movable body being capable of oscillating in a left-right direction relative to the housing, wherein the movable body includes a core extending in a front-rear direction, and a coil wound around the core in the front-rear direction, a permanent magnet is fixed inside the housing on an extension of the core in the front-rear direction, both poles of which face one end of the core, and are arranged along the left-right direction, an inertial force in a direction opposite to a movement of the movable body is alternately transmitted to the housing, the support is a guide by which a movement of the movable body is restricted in the front-rear direction and a vertical direction, yet is allowed in the left-right direction, and the movable body is configured to move leftward when a current in one direction flows through the coil, with a further movement leftward being restricted by an attractive force between the one end of the core and one pole of the permanent magnet, and move rightward when a current in another direction flows through the coil, with a further movement rightward being restricted by an attractive force between the one end of the core and another pole of the permanent magnet.

According to the vibrator of one embodiment, the frequency characteristic of the vibrator can be flattened.

### BRIEF DESCRIPTION OF THE DRAWINGS

FIG. 1 is an external perspective view of a vibrator according to one embodiment;

FIG. 2 is an exploded perspective view of the vibrator according to one embodiment;

FIG. 3 is an external perspective view illustrating an internal configuration of the vibrator according to one embodiment;

FIG. 4 is a top view illustrating the internal configuration of the vibrator according to one embodiment;

FIG. 5 is a side view illustrating the internal configuration of the vibrator according to one embodiment;

FIG. 6A is a drawing describing an operation of a movable body provided in the vibrator according to one embodiment;

FIG. 6B is a drawing describing the operation of the movable body provided in the vibrator according to one embodiment;

FIG. 7A is a drawing describing the operation of the movable body provided in the vibrator according to one embodiment;

FIG. 7B is a drawing describing the operation of the movable body provided in the vibrator according to one embodiment; and

FIG. 8 is a cross-sectional view illustrating a support configuration of a core in the vibrator according to one embodiment.

### DESCRIPTION OF THE PREFERRED EMBODIMENTS

In the following, one embodiment of the present invention will be described with reference to the accompanying drawings.

### (Configuration of Vibrator 10)

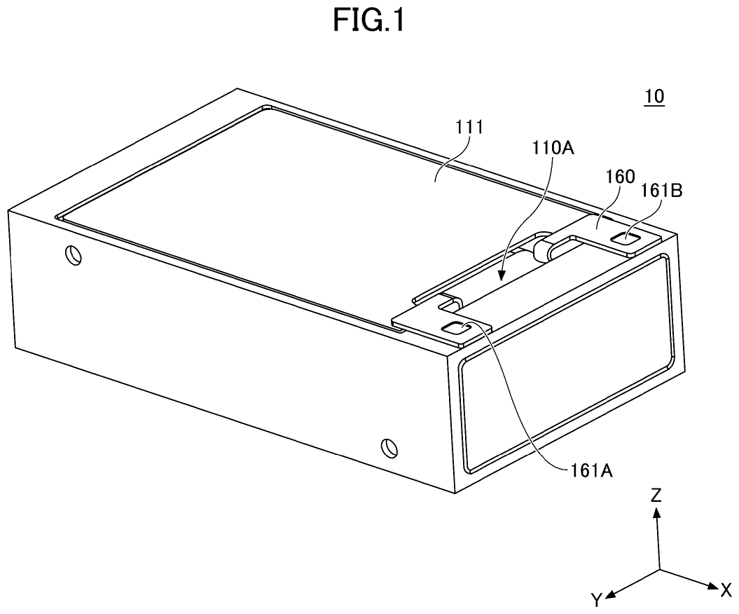

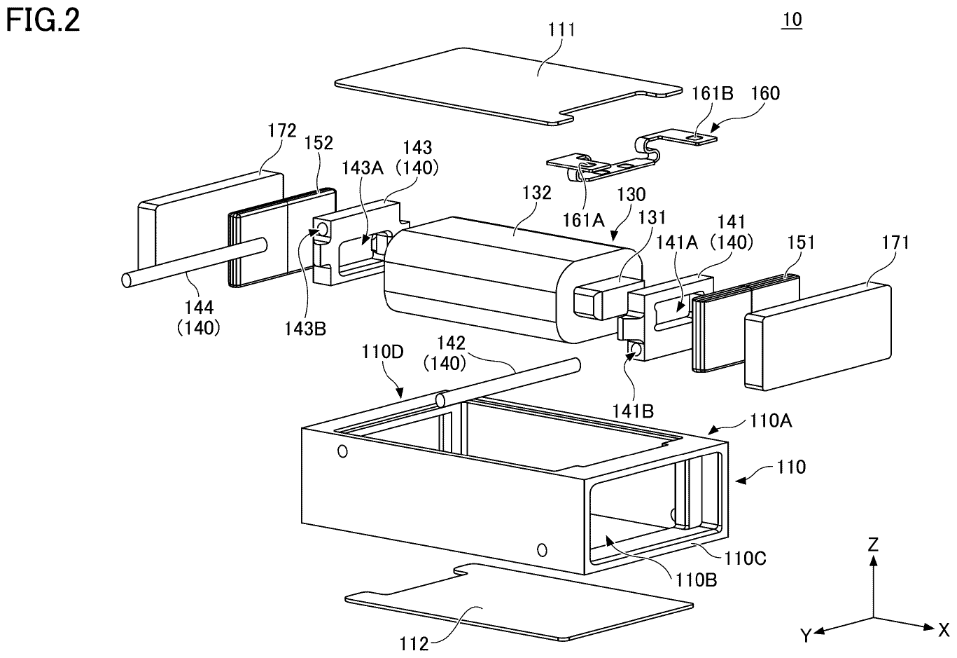

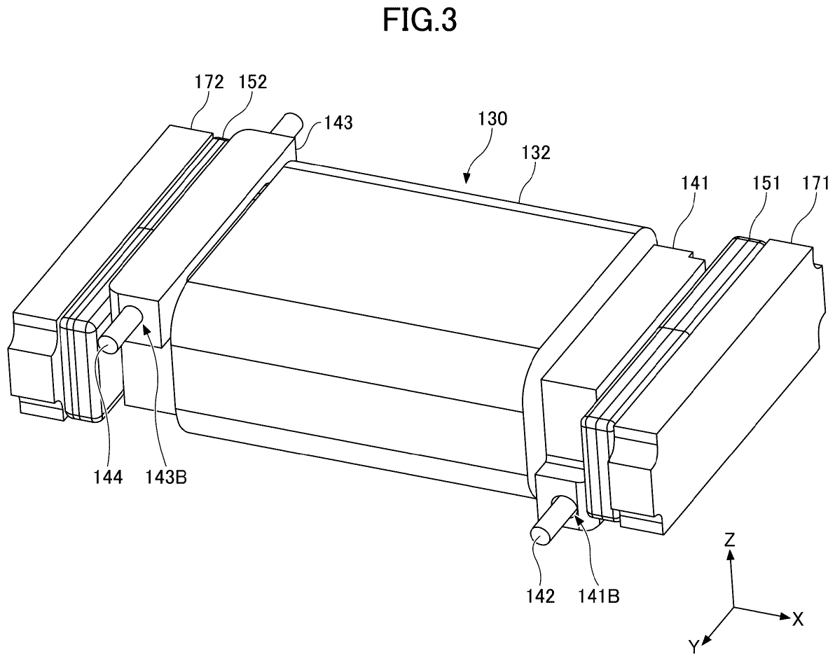

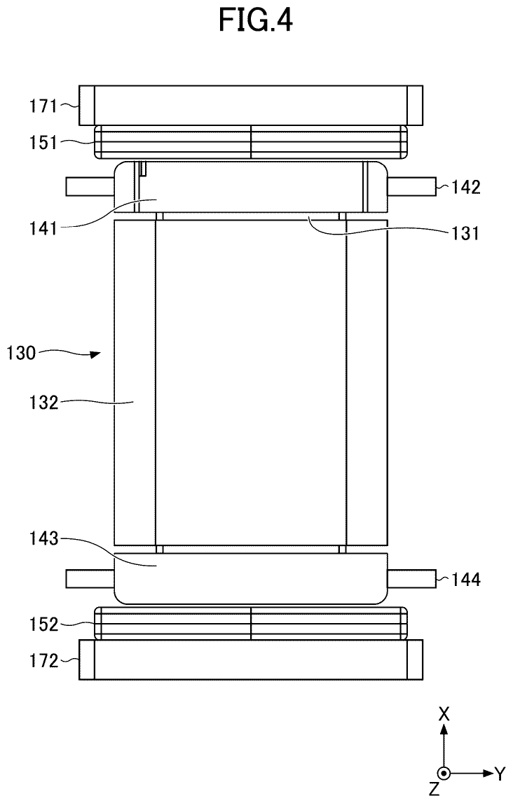

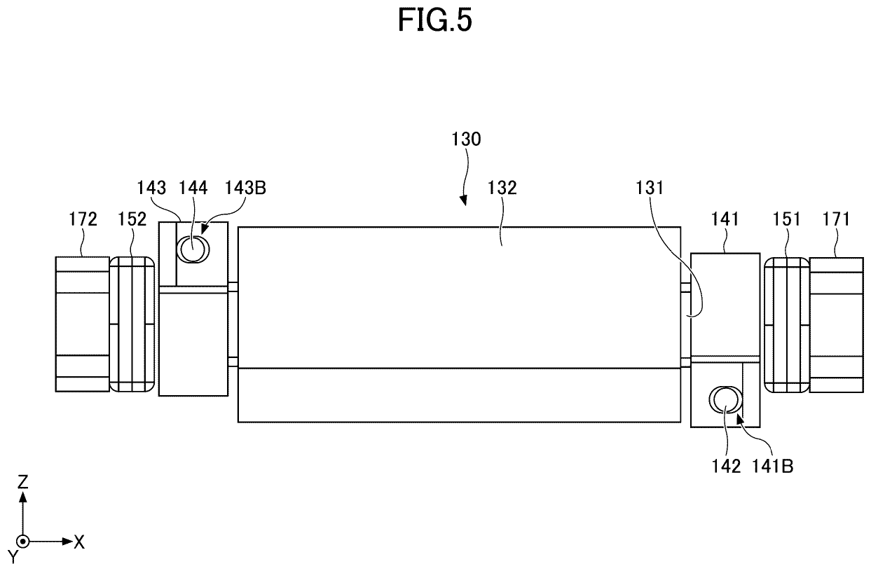

FIG. 1 is an external perspective view of a vibrator 10 according to one embodiment. FIG. 2 is an exploded perspective view of the vibrator 10 according to one embodiment. FIG. 3 is an external perspective view illustrating an internal configuration of the vibrator 10 according to one embodiment. FIG. 4 is a top view illustrating the internal configuration of the vibrator 10 according to one embodiment. FIG. 5 is a side view illustrating the internal configuration of the vibrator 10 according to one embodiment.

In the following description, for convenience, a Z-axis direction in the figure is referred to as a vertical direction, an X-axis direction in the figure is a front-rear direction, and a Y-axis direction in the figure is a left-right direction. Additionally, a Z-axis positive direction is an upward direction, an X-axis positive direction is a front direction, and a Y-axis positive direction is a right direction.

The vibrator 10 shown in FIGS. 1 to 5 is a device mounted on electronic devices such as a mobile device (e.g., a smartphone, a mobile phone, a tablet terminal, etc.), a game machine, and an information display mounted on a vehicle such as an automobile. The vibrator 10 is used, for example, to generate vibration to give a user notification of various incoming communications (e.g., an incoming call, an incoming e-mail, an incoming SNS message) and tactile feedback on user operations, and the like.

As shown in FIGS. 1 to 5, the vibrator 10 includes a housing 110, a movable body 130, a support 140, a permanent magnet 151, a permanent magnet 152, FPC (Flexible Printed Circuits) 160, a yoke 171, and a yoke 172.

The housing 110 is a container-like member having a rectangular parallelepiped shape in the vertical direction (Z-axis direction in the figure). The housing 110 houses the movable body 130 and the support 140 inside. For example, the housing 110 is formed of a metal material.

The housing 110 has a rectangular upper opening 110A on the upper surface in plan view, and a rectangular lower opening 110B on the lower surface in plan view. The upper opening 110A is closed by a rectangular and flat lid 111. The lower opening 110B is closed by a rectangular and flat lid 112.

The housing 110 has a front holding part 110C which is rectangular in plan view for holding the permanent magnet 151 and the yoke 171, and a rear holding part 110D which is rectangular in plan view for holding the permanent magnet 152 and the yoke 172.

The movable body 130 is housed inside the housing 110 and oscillates in the left-right direction (Y-axis direction in the figure). The movable body 130 has a core 131 extending in the front-rear direction (X-axis direction in the figure), and a coil 132 wound around the core 131 in the front-rear direction (X-axis direction in the figure). For example, the core 131 is formed by using a ferromagnetic material such as iron. The coil 132 is formed by using a copper wire or the like. The coil 132 is connected to the FPC 160 by soldering or the like.

The movable body 130 generates an alternating magnetic field around the movable body 130 by supplying a current from an external circuit to the coil 132 through the FPC 160. Thus, while one end of the core 131 and the other end of the core 131 are magnetized to different magnetic poles, one end of the core 131 and the other end of the core 131 are magnetized alternately to the north pole and the south pole, and the movable body 130 oscillates in the left-right direction (Y-axis direction in the figure) inside the housing 110.

The support 140 is housed inside the housing 110 and supports the movable body 130, the movable body 130 being capable of oscillating in the left-right direction (Y-axis direction in the figure) relative to the housing 110. The support 140 has a front bearing member 141, a front shaft member 142, a rear bearing member 143, and a rear shaft member 144.

The front shaft member 142 is a rod-shaped member fixed at a position in front of the movable body 130 and extending in the left-right direction.

The front bearing member 141 is a block-shaped and annular member mounted at the front end of the core 131. The front bearing member 141 includes a rectangular mounting through-hole 141A in plan view that penetrates the front bearing member 141 in the front-rear direction (X-axis direction in the figure). The front bearing member 141 supports the front end of the core 131 by fitting the front end of the core 131 into the mounting through-hole 141A. The front bearing member 141 includes a guide through-hole 141B formed along the left-right direction (Y-axis direction in the figure) through which the front shaft member 142 is inserted.

When the front shaft member 142 is inserted into the guide through-hole 141B, the front bearing member 141 can be moved along the left-right direction (Y-axis direction in the figure) by the front shaft member 142, and movement along the vertical direction (Z-axis direction in the figure) and the front-rear direction (X-axis direction in the figure) is restricted.

Both the right and left lateral surfaces of the front bearing member 141 functioning as stoppers abut an inner wall surface of the housing 110, which restricts an amount of vibration movement along the left-right direction (Y-axis direction in the figure) of the movable body 130 to a predetermined maximum amount of movement.

The rear shaft member 144 is a rod-shaped member fixed at a position in rear of the movable body 130 and extending in the left-right direction.

The rear bearing member 143 is a block-shaped and annular member attached to the rear end of the core 131. The rear bearing member 143 includes a rectangular mounting through-hole 143A in plan view that penetrates the rear bearing member 143 in the front-rear direction (X-axis direction in the figure). The front bearing member 141 supports the rear end of the core 131 by fitting the rear end of the core 131 into the mounting through-hole 143A. The rear bearing member 143 includes a guide through-hole 143B formed along the left-right direction (Y-axis direction in the figure) through which the rear shaft member 144 is inserted.

When the rear shaft member 144 is inserted into the guide through-hole 143B, the rear bearing member 143 can be moved along the left-right direction (Y-axis direction in the figure) by the rear shaft member 144, and movement along the vertical direction (Z-axis direction in the figure) and the front-rear direction (X-axis direction in the figure) is restricted.

The both right and left lateral surfaces of the rear bearing member 143 functioning as stoppers abut the inner wall surface of the housing 110, which restricts the amount of vibration movement along the left-right direction (Y-axis direction in the figure) of the movable body 130 to a predetermined maximum amount of movement.

Therefore, the movable body 130 supported by the front bearing member 141 and the rear bearing member 143, together with the front bearing member 141 and the rear bearing member 143, can be moved along the left-right direction (Y-axis direction in the figure) and movement along the vertical direction (Z-axis direction in the figure) and the front-rear direction (X-axis direction in the figure) is restricted.

In other words, the support 140 is a “guide” by which a movement of the movable body 130 is restricted in the front-rear direction and a vertical direction, and is not prevented in the left-right direction.

As shown in FIGS. 2, 3, and 5, in the front bearing member 141, the guide through-hole 141B is disposed below the mounting through-hole 141A (Z-axis negative direction in the figure). In the rear bearing member 143, the guide through-hole 143B is disposed above the mounting through-hole 143A (Z-axis positive direction in the figure).

Thus, the vibrator 10 according to one embodiment can support the front end of the core 131 and the rear end of the core 131 in a balanced manner using the front bearing member 141 and the rear bearing member 143, and thus can guide the vibration of the movable body 130 in the left-right direction in a balanced manner.

The permanent magnet 151 is fitted into a front holding part 110C of the housing 110 together with the yoke 171, and is held by the front holding part 110C while facing the front end of the core 131. The permanent magnet 151 has a horizontal rectangular shape in plan view in the front-rear direction (X-axis direction in the figure). The left half of the permanent magnet 151, facing the front end of the core 131, is magnetized to the south pole, and the right half is magnetized to the north pole.

The permanent magnet 152 is fitted into a rear holding part 110D of the housing 110 together with the yoke 172, and is held by the rear holding part 110D while facing the rear end of the core 131. The permanent magnet 152 has a horizontal rectangular shape in plan view from the front-rear direction (X-axis direction in the figure). The left half of the permanent magnet 152, facing the rear end of the core 131, is magnetized to the south pole, and the right half is magnetized to the north pole.

The FPC 160 is a member for connecting the coil 132 and an external circuit (not shown) in order to supply an AC current to the coil 132 of the movable body 130. The FPC 160 is a film-shaped member having a structure in which an interconnect made of a metal film is interposed by a resin material such as polyimide. Since the FPC 160 is flexible, it can be bent. As shown in FIG. 1, a part of the FPC 160 is exposed from the upper surface of the housing 110, and two electrode terminals 161A and 161B made of a metal film and connected to the external circuit are formed in the exposed portion.

The vibrator 10 according to one embodiment configured as described above generates an alternating magnetic field around the coil 132 by supplying an alternating current to the coil 132 from the external circuit via the FPC 160. As a result, the movable body 130 vibrates along the left-right direction (Y-axis direction in the figure) due to attractive force and repulsive force generated between the movable body and the permanent magnets 151 and 152. By the vibration of the movable body 130 along the left-right direction (Y-axis direction in the figure), inertial force in the opposite direction of the movement of the movable body 130 is alternately transmitted to the housing 110.

At this time, in the vibrator 10 according to one embodiment, since the movable body 130 is supported by the support 140, the movable body 130 is guided to move along the left-right direction (Y-axis direction in the figure) by the support 140, and is restricted to move along the vertical direction (Z-axis direction in the figure) and the front-rear direction (X-axis direction in the figure).

As a result, according to the vibrator 10 according to one embodiment, the frequency characteristic of the vibrator can be flattened (i.e., can increase the bandwidth of the peak resonant frequency).

In particular, in the vibrator 10 according to one embodiment, the support 140 supports the movable body 130 in such a manner s to allow oscillation of the movable body 130 in the left-right direction relative to the housing 110 without using an elastic member.

As a result, according to the vibrator 10 embodiment, the frequency according to one characteristic of the vibrator can be flattened (i.e., to increase the bandwidth of the peak resonant frequency) as compared with the conventional technology in which the movable body is supported by an elastic member.

Moreover, since the support 140 (guide) of the vibrator 10 according to one embodiment includes a front bearing member 141, a front shaft member 142, a rear bearing member 143, and a rear shaft member 144, the vibration of the movable body 130 in the front-rear and left-right directions when the movable body 130 vibrates can be reduced.

### (Operation of Movable Body 130)

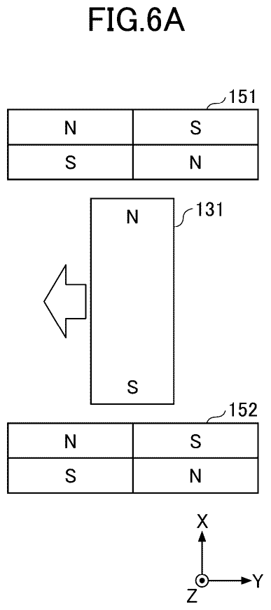

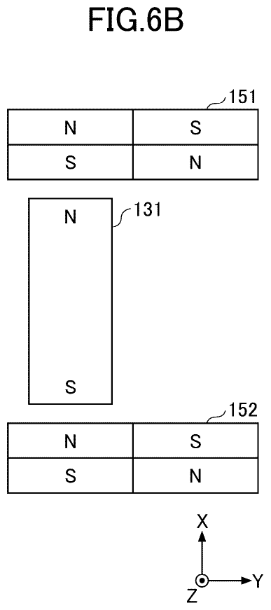

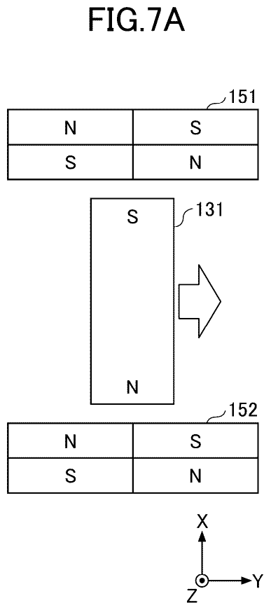

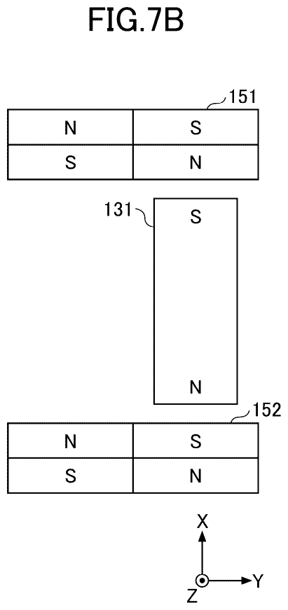

FIGS. 6A to 7B are drawings describing an operation of the movable body 130 provided in the vibrator 10 according to one embodiment.

As shown in FIGS. 6A to 7B, the left half of the permanent magnet 151, facing the front end of the core 131, is magnetized to the south pole, and the right half is magnetized to the north pole. The left half of the permanent magnet 152, facing the rear end of the core 131, is magnetized to the south pole, and the right half is magnetized to the north pole.

In the vibrator 10 of the present embodiment, when an AC current does not flow through the coil 132 constituting the movable body 130, as shown in FIGS. 6A and 7A, the core 131 is kept at an intermediate position in the left-right direction (Y-axis direction in the figure) by the magnetic attractive force of the permanent magnet 151 and 152.

In the vibrator 10 of the present embodiment, an alternating magnetic field is generated around the movable body 130 by flowing an AC current through the coil 132 constituting the movable body 130, and both ends of the core 131 are magnetized so that both ends of the core 131 have different polarities.

For example, as shown in FIG. 6A, when a current flows through the coil 132 in one direction, the front end of the core 131 is magnetized to the north pole, and the rear end of the core 131 is magnetized to the south pole.

In this case, the front end of the core 131 experiences both an attractive force toward the south pole of the left half of permanent magnet 151 and a repulsive force from the north pole of the right half.

Simultaneously, the rear end of the core 131 generates an attractive force that is attracted to the north pole of the left half of the permanent magnet 152, and a repulsive force that is repelled from the south pole of the right half of the permanent magnet 152.

Thus, as shown in FIG. 6B, the movable body 130 moves leftward (Y-axis negative direction in the figure), with the leftward (Y-axis negative direction in the figure) movement being restricted by the attractive force between the front end of the core 131 and the south pole of the left half of the permanent magnet 151, and by the attractive force between the rear end of the core 131 and the north pole of the left half of the permanent magnet 152.

Also, as shown in FIG. 7A, for example, when a current flows in the coil 132 in the other direction, the front end of the core 131 is magnetized to the south pole, and the rear end of the core 131 is magnetized to the north pole.

In this case, the front end of the core 131 generates an attractive force attracted to the north pole of the right half of the permanent magnet 151, and a repulsive force repelled from the south pole of the left half of the permanent magnet 151.

At the same time, the rear end of the core 131 generates an attractive force attracted to the south pole of the right half of the permanent magnet 152, and a repulsive force repelled from the north pole of the left half of the permanent magnet 152.

Thus, as shown in FIG. 7B, the movable body 130 moves rightward (Y-axis positive direction in the figure), with the rightward (Y-axis positive direction in the figure) movement being restricted by the attractive force between the front end of the core 131 and the north pole of the right half of the permanent magnet 151, and by the attractive force between the rear end of the core 131 and the south pole of the right half of the permanent magnet 152.

### (Support Configuration of Core 131)

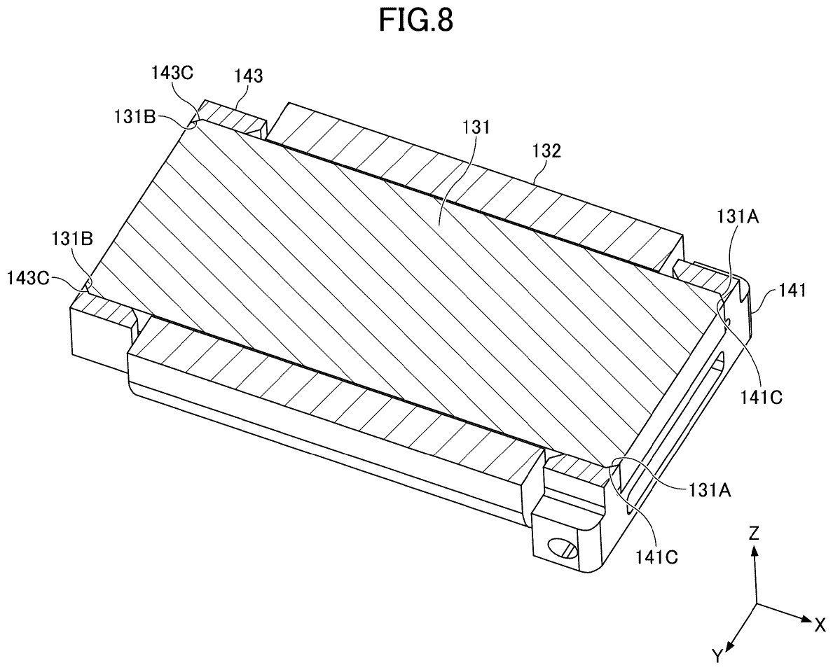

FIG. 8 is a cross-sectional view illustrating a support configuration of the core 131 in the vibrator 10 according to one embodiment. FIG. 8 shows cross sections parallel to an XY-plane of the core 131, the front bearing member 141, and the rear bearing member 143.

As shown in FIG. 8, front chamfering parts 131A are formed at the front end (both right and left corners) of the core 131. Additionally, in the mounting through-hole 141A of the front bearing member 141, front abutting parts 141C abutting on the front chamfering parts 131A of the core 131 are formed projecting inward.

As shown in FIG. 8, when the front end of the core 131 is inserted into the mounting through-hole 141A of the front bearing member 141, the front chamfering parts 131A of the core 131 abut on the front abutting parts 141C of the front bearing member 141.

Thus, in the vibrator 10 according to one embodiment, the mounting position of the front bearing member 141 to the core 131 is restricted. That is, since the vibrator 10 according to one embodiment can improve the accuracy of the mounting position of the core 131 to the front bearing member 141, the disturbance of the alternating magnetic field generated around the movable body 130 can be reduced.

Similarly, rear chamfering parts 131B are formed at the rear end (both right and left corners) of the core 131. Additionally, in the mounting through-hole 143A of the rear bearing member 143, rear abutting parts 143C abutting on the rear chamfering parts 131B of the core 131 are formed projecting inward.

When the front end of the core 131 is inserted into the mounting through-hole 143A of the rear bearing member 143, the rear chamfering parts 131B of the core 131 abut on the rear abutting parts 143C of the rear bearing member 143.

Thus, in the vibrator 10 according to one embodiment, the mounting position of the rear bearing member 143 to the core 131 is restricted. That is, since the vibrator 10 according to one embodiment can improve the accuracy of the mounting position of the core 131 to the rear bearing member 143, the disturbance of the alternating magnetic field generated around the movable body 130 can be reduced.

Further, the present invention is not limited to these embodiments, but various variations and modifications may be made without departing from the scope of the present invention.

What is claimed is:

1. A vibrator comprising:
a housing;
a movable body housed in the housing; and
a support configured to support the movable body, the movable body being capable of oscillating in a left-right direction relative to the housing,
wherein
the movable body includes a core extending in a front-rear direction, and a coil wound around the core in the front-rear direction;
a permanent magnet is fixed inside the housing on an extension of the core in the front-rear direction, both poles of which face one end of the core, and arranged are along the left-right direction;
an inertial force in a direction opposite to a movement of the movable body is alternately transmitted to the housing;
the support is a guide by which a movement of the movable body is restricted in the front-rear direction and a vertical direction, yet is allowed in the left-right direction; and
the movable body is configured to move leftward when a current in one direction flows through the coil, with a further movement leftward being restricted by an attractive force between the one end of the core and one pole of the permanent magnet, and move rightward when a current in another direction flows through the coil, with a further movement rightward being restricted by an attractive force between the one end of the core and another pole of the permanent magnet.

2. The vibrator according to claim 1, wherein the guide includes:
a front shaft member fixed at a position in front of the movable body and extending in the left-right direction;
a front bearing member mounted at a front end of the core and provided with a guide through-hole in the left-right direction through which the front shaft member is inserted;
a rear shaft member fixed at a position in rear of the movable body and extending in the left-right direction; and
a rear bearing member mounted at a rear end of the core and provided with a guide through-hole in the left-right direction through which the rear shaft member is inserted.

3. The vibrator according to claim 2, wherein:
the front bearing member includes an annular member having a mounting through-hole extending in the front-rear direction into which the front end of the core is inserted, and the guide through-hole through which the front shaft member is inserted is arranged below the mounting through-hole; and
the rear bearing member includes an annular member having a mounting through-hole extending in the front-rear direction into which the rear end of the core is inserted, and the guide through-hole through which the rear shaft member is inserted is arranged above the mounting through-hole.

4. The vibrator according to claim 2, wherein:
a front chamfering part is formed at the front end of the core;
a front abutting part for abutting on the front chamfering part is formed in the front bearing member; and
a mounting position of the front bearing member to the core is restricted by the front abutting part abutting on the front chamfering part.

5. The vibrator according to claim 2, wherein the support is configured to support the movable body in such a manner as to allow oscillation of the movable body in the left-right direction relative to the housing without using an elastic member.
